(19) United States
(12) Patent Application Publication
(10) Pub. No.: US 2025/0021065 A1
(43) Pub. Date: Jan. 16, 2025

(54) PERFORMING COMBINED AC AND DC TELEMETRY WITH A SINGLE ADC USING COUPLED PCB TRACES

(71) Applicant: Lenovo Enterprise Solutions (Singapore) Pte. Ltd., New Tech Park (SG)

(72) Inventors: Grason Humphrey, Raleigh, NC (US); Eric Li, Chapel Hill, NC (US); Milton Cobo, Raleigh, NC (US); Michael DeCesaris, Carrboro, NC (US)

(21) Appl. No.: 18/220,487

(22) Filed: Jul. 11, 2023

(51) Int. Cl. G05B 15/02

(52) U.S. Cl. CPC G05B 15/02

(57) ABSTRACT

An apparatus includes a first conductor connected to a pin of a controller, where the first conductor includes a low frequency first signal component, and second conductor with a high frequency second signal component. A coupling section includes part of the first conductor situated in proximity to part of the second conductor. The second signal induces an induced signal on the first conductor within the coupling section. The high frequency is at least an order of magnitude higher than the low frequency. The apparatus includes the controller with a first signal monitor configured to monitor the first signal present on the pin of the controller and to report a status of the first signal, and a second signal monitor configured to monitor the second signal by monitoring the induced signal present on the pin and to report a status of the second signal based on the induced signal.

### FIELD

The subject matter disclosed herein relates to telemetry and more particularly relates to combining a high frequency signal onto a low frequency conductor allowing combined telemetry using a single pin of a controller.

### BACKGROUND

Traffic on clock and data lines can provide valuable information for monitoring and debugging computer systems. However, because monitoring these clock and data signals requires valuable field programmable gate array (“FPGA”) pins, controller pins, or board space, these signals are often not monitored.

### BRIEF SUMMARY

An apparatus for combining low frequency and high frequency telemetry using coupled conductors includes a first conductor connected to a pin of a controller. The first conductor includes a first signal with a low frequency signal component. The apparatus includes a second conductor with a second signal. The second signal includes a high frequency signal component. The apparatus includes a coupling section with a portion of the first conductor situated in proximity to a portion of the second conductor. The high frequency signal component of the second signal on the second conductor induces an induced signal on the first conductor within the coupling section. The induced signal includes the high frequency signal component that is at least an order of magnitude higher than the low frequency signal component. The apparatus includes the controller with a first signal monitor configured to monitor the first signal present on the pin of the controller and to report a status of the first signal, and a second signal monitor configured to monitor the second signal by monitoring the induced signal present on the pin and to report a status of the second signal based on the induced signal.

Another apparatus for combining low frequency and high frequency telemetry using coupled conductors includes a first conductor connected to a pin of a controller, where the first conductor includes a first signal with a DC voltage, a second conductor that includes a second signal with a digital signal, and a coupling section with a portion of the second conductor situated in proximity to a portion of the first conductor. A frequency the digital signal of the second signal of the second conductor induces an induced signal on the first conductor within the coupling section. The induced signal includes the frequency of the digital signal that is at least an order of magnitude higher than harmonic frequencies of the first signal. The controller includes a first signal monitor configured to monitor the first signal present on the pin of the controller and to report a status of the first signal, and a second signal monitor configured to monitor the second signal by monitoring the induced signal present on the pin and to report a status of the second signal based on the induced signal.

A computing device for combining low frequency and high frequency telemetry using coupled conductors includes a processor, a memory coupled to the processor, a power supply, a first conductor connected to the power supply and to a pin of a controller where the first conductor includes a first signal with a low frequency signal component, and a second conductor with a second signal where the second signal includes a high frequency signal component. The computing device includes a coupling section with a portion of the first conductor situated in proximity to a portion of the second conductor. The high frequency signal component of the second signal on the second conductor induces an induced signal on the first conductor within the coupling section and the induced signal with the high frequency signal component is at least an order of magnitude higher than the low frequency signal. The controller includes a first signal monitor configured to monitor the first signal present on the pin of the controller and to report a status of the first signal and a second signal monitor configured to monitor the second signal by monitoring the induced signal present on the pin and to report a status of the second signal based on the induced signal.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for combining low frequency and high frequency telemetry using coupled conductors, according to various embodiments;

FIG. 2 is a schematic block diagram illustrating an apparatus for combining low frequency and high frequency telemetry using coupled conductors, according to various embodiments;

FIG. 3 is a schematic block diagram illustrating another apparatus for combining low frequency and high frequency telemetry using coupled conductors, according to various embodiments;

FIG. 4 is a schematic block diagram illustrating a first configuration for combining low frequency and high frequency telemetry using coupled conductors using printed circuit board traces, according to various embodiments;

FIG. 5 is a schematic block diagram illustrating a second configuration for combining low frequency and high frequency telemetry using coupled conductors of a cable, according to various embodiments;

FIG. 6 is a schematic block diagram illustrating a third configuration for combining low frequency and high frequency telemetry using coupled conductors using a capacitor, according to various embodiments;

FIG. 7 is a voltage versus time diagram illustrating a DC signal and an induced signal, according to various embodiments; and

FIG. 8 is a schematic flow chart diagram illustrating a method for combining low frequency and high frequency telemetry using coupled conductors, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “monitor,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules or monitors, in order to more particularly emphasize their implementation independence. For example, a module or monitor may be implemented as a hardware circuit comprising custom very large scale integrated (“VLSI”) circuits or gate arrays, off-the-shelf semiconductors such as logic chips, transistors, or other discrete components. A module or monitor may also be implemented in programmable hardware devices such as a field programmable gate array (“FPGA”), programmable array logic, programmable logic devices or the like.

Modules and monitors may also be implemented in code and/or software for execution by various types of processors. An identified module or monitor of code may, for instance, comprise one or more physical or logical blocks of executable code which may, for instance, be organized as an object, procedure, or function. Nevertheless, the executables of an identified module or monitor need not be physically located together, but may comprise disparate instructions stored in different locations which, when joined logically together, comprise the module or monitor and achieve the stated purpose for the module or monitor.

Indeed, a module or monitor of code may be a single instruction, or many instructions, and may even be distributed over several different code segments, among different programs, and across several memory devices. Similarly, operational data may be identified and illustrated herein within modules or monitors, and may be embodied in any suitable form and organized within any suitable type of data structure. The operational data may be collected as a single data set, or may be distributed over different locations including over different computer readable storage devices. Where a module or monitor or portions of a module or monitor are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules or monitors, user selections, network transactions, database queries, database structures, hardware modules, hardware monitors, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, a monitor, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for combining low frequency and high frequency telemetry using coupled conductors includes a first conductor connected to a pin of a controller. The first conductor includes a first signal with a low frequency signal component. The apparatus includes a second conductor with a second signal. The second signal includes a high frequency signal component. The apparatus includes a coupling section with a portion of the first conductor situated in proximity to a portion of the second conductor. The high frequency signal component of the second signal on the second conductor induces an induced signal on the first conductor within the coupling section. The induced signal includes the high frequency signal component that is at least an order of magnitude higher than the low frequency signal component. The apparatus includes the controller with a first signal monitor configured to monitor the first signal present on the pin of the controller and to report a status of the first signal, and a second signal monitor configured to monitor the second signal by monitoring the induced signal present on the pin and to report a status of the second signal based on the induced signal.

In some embodiments, the first conductor monitors a direct current DC signal and the controller includes an analog-to-digital converter connected to the pin of the controller configured to provide a digitized version of an analog signal present at the pin to the first signal monitor. In the embodiments, the first signal monitor monitors a DC level of the first conductor. In other embodiments, the second signal of the second conductor includes a digital signal and the controller includes an analog-to-digital converter connected to the pin of the controller configured to provide a digitized version of an analog signal at the pin to the second signal monitor and the second signal monitor monitors a frequency of the induced signal matching a frequency of the digital signal. In other embodiments, the second signal monitor utilizes one of a Fast Fourier Transform and a digital filter. In other embodiments, the second signal monitor monitors an amplitude of the induced signal and/or presence and non-presence of the induced signal.

In some embodiments, the coupling section includes a portion of the first conductor and a portion of the second conductor configured as traces on a printed circuit board (“PCB”) situated in close proximity to induce the high frequency signal component of the second conductor onto the first conductor. In other embodiments, the coupling section includes a portion of the first conductor and a portion of the second conductor configured in a cable. The portion of the first conductor and the portion of the second conductor are unshielded and are in close proximity to induce the high frequency signal component of the second conductor onto the first conductor. In other embodiments, the coupling section includes a coupling capacitor coupled the first conductor and to the second conductor at the coupling section. The coupling capacitor is sized and situated to induce the high frequency signal component of the second conductor onto the first conductor.

In some embodiments, the apparatus includes a low pass filter configured to filter the first conductor. The coupling section is positioned between the low pass filter and the pin of the controller. In other embodiments, the coupling section is configured to create a coupling coefficient between the first conductor and the second conductor sufficient such that the induced signal has a maximum amplitude that is detectable by the second signal monitor and is smaller than a maximum amplitude of the first signal. In other embodiments, the apparatus includes a first alert module configured to report a status of the first signal and/or an anomaly associated with the first signal, and the apparatus includes a second alert module configured to report a status of the second signal and/or an anomaly associated with the second signal based on the second signal monitor monitoring the induced signal.

Another apparatus for combining low frequency and high frequency telemetry using coupled conductors includes a first conductor connected to a pin of a controller, where the first conductor includes a first signal with a DC voltage, a second conductor that includes a second signal with a digital signal, and a coupling section with a portion of the second conductor situated in proximity to a portion of the first conductor. A frequency the digital signal of the second signal of the second conductor induces an induced signal on the first conductor within the coupling section. The induced signal includes the frequency of the digital signal that is at least an order of magnitude higher than harmonic frequencies of the first signal. The controller includes a first signal monitor configured to monitor the first signal present on the pin of the controller and to report a status of the first signal, and a second signal monitor configured to monitor the second signal by monitoring the induced signal present on the pin and to report a status of the second signal based on the induced signal.

In some embodiments, the controller includes an analog-to-digital converter connected to the pin of the controller. The analog-to-digital converter provides a digitized version of an analog signal present at the pin of the controller to the first signal monitor and to the second signal monitor. In other embodiments, the second signal monitor utilizes one of a Fast Fourier Transform and a digital filter and/or the second signal monitor monitors an amplitude of the induced signal and/or presence and non-presence of the induced signal.

In some embodiments, the coupling section includes a portion of the first conductor and a portion of the second conductor configured as traces on a PCB situated in close proximity to induce the digital signal of the second conductor onto the first conductor. In other embodiments, the coupling section includes a portion of the first conductor and a portion of the second conductor configured in a cable where the portion of the first conductor and the portion of the second conductor are unshielded and are in close proximity to induce the digital signal of the second conductor onto the first conductor. In other embodiments, the coupling section includes a coupling capacitor coupled the first conductor and to the second conductor at the coupling section. The coupling capacitor is sized and situated to induce the digital signal of the second conductor onto the first conductor.

In some embodiments, the apparatus includes a low pass filter configured to filter the first conductor where the coupling section is positioned between the low pass filter and the pin of the controller. In other embodiments, the coupling section is configured to create a coupling coefficient between the first conductor and the second conductor sufficient such that the induced signal has a maximum amplitude that is detectable by the second signal monitor and is smaller than a maximum of the first signal. In other embodiments, the apparatus includes a first alert module configured to report a status of the first signal and/or an anomaly associated with the first signal, and the apparatus includes a second alert module configured to report a status of the second signal and/or an anomaly associated with the second signal based on the second signal monitor monitoring the induced signal.

A computing device for combining low frequency and high frequency telemetry using coupled conductors includes a processor, a memory coupled to the processor, a power supply, a first conductor connected to the power supply and to a pin of a controller where the first conductor includes a first signal with a low frequency signal component, and a second conductor with a second signal where the second signal includes a high frequency signal component. The computing device includes a coupling section with a portion of the first conductor situated in proximity to a portion of the second conductor. The high frequency signal component of the second signal on the second conductor induces an induced signal on the first conductor within the coupling section and the induced signal with the high frequency signal component is at least an order of magnitude higher than the low frequency signal component. The controller includes a first signal monitor configured to monitor the first signal present on the pin of the controller and to report a status of the first signal and a second signal monitor configured to monitor the second signal by monitoring the induced signal present on the pin and to report a status of the second signal based on the induced signal.

In some embodiments, the computing device includes a low pass filter configured to filter the first conductor. The coupling section is positioned between the low pass filter and the pin of the controller. In other embodiments, the computing device includes a first alert module configured to report a status of the first signal and/or an anomaly associated with the first signal, and a second alert module configured to report a status of the second signal and/or an anomaly associated with the second signal based on the second signal monitor monitoring the induced signal.

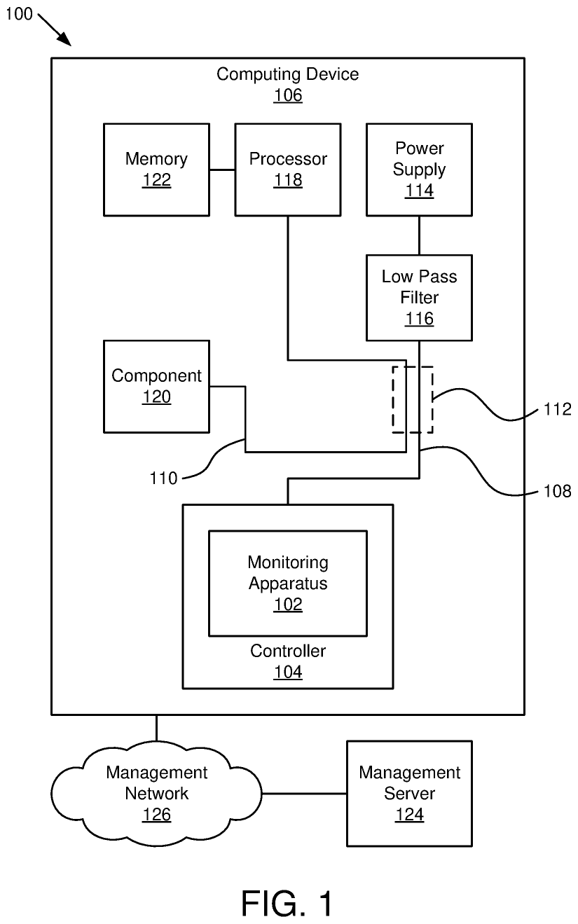

FIG. 1 is a schematic block diagram illustrating a system 100 for combining low frequency and high frequency telemetry using coupled conductors, according to various embodiments. The system 100 includes a monitoring apparatus 102 in a controller 104 of a computing device 106. A first conductor 108 connects to the controller 104 and a second conductor 110 is coupled to the first conductor 108 in a coupling section 112, which induces a signal from the second conductor 110 onto the first conductor 108 so that the monitoring apparatus 102 is able to monitor a first signal from the first conductor 108 and an induced signal from a second signal from the second conductor 110 using a single pin of the controller 104. The first signal has low frequency signals (e.g., low frequency signal component) or a direct current (“DC”) signal while the second signal has a high frequency signal (e.g., high frequency signal component) which is at least an order of magnitude (e.g., 10×) higher than the low frequency (or DC) of the first signal. As used herein, monitoring the first signal that is low frequency includes monitoring a first signal that is DC. Beneficially, combining the first signal and a representation of the second signal together on the first conductor 108 decreases the number of pins required to be used on the controller 104. The monitoring apparatus 102 and coupling section are described in more detail below.

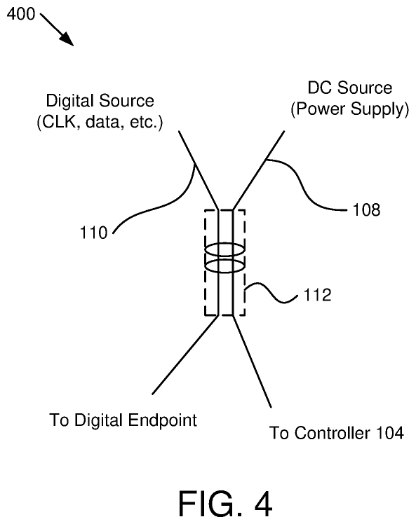

The computing device 106 also includes a power supply 114 feeding the first conductor 108 through a potential low pass filter 116. In other embodiments, the first conductor 108 is connected to a different device being monitored by the controller 104. The second conductor 110 is connected to a digital source, such as a processor 118, a graphics processing unit (“GPU”), memory 122, or the like and connects to at least one component 120 as a digital endpoint. The second conductor 110, in various embodiments, includes a high frequency signal running between any two components of a computing device 106. In the case of something like a clock signal, often denoted by “CLK,” the second conductor 110 may connect to several components 120. The coupling section 112 provides a way to couple alternating current (“AC”) signals from the second conductor onto the first conductor 108. The coupling section 112 may be implemented in various ways, such as those described below with respect to FIGS. 4-6.

The controller 104 includes a monitoring and/or telemetry function, which provides information about various signals, such as voltage levels, presence or lack of a particular signal, etc. In some embodiments, the controller 104 is an FPGA. In other embodiments, the controller 104 is a service processor, such as a baseboard management controller (“BMC”). In some embodiments, the service processor is an XClarity® Controller (“XCC”) by Lenovo®. In other embodiments, the controller 104 is the processor 118. One of skill in the art will recognize other devices used to monitor signals in a computing device 106.

The computing device 106, in some embodiments, is a server, such as a rack-mounted server in a datacenter. In other embodiments, the computing device 106 is a desktop computer, a workstation, a laptop computer, a mainframe computer, a tablet computer, a smartphone, a smartwatch, a smart appliance, an internet-of-things device, a motor controller, a power switching device, or any other computing device or device with digital functions that would benefit from combining an AC signal onto a low frequency or DC signal for monitoring.

The power supply 114 typically provides one or more DC voltages. In some embodiments, the power supply 114 provides AC control power, such as 24 volt (“V”) AC control power where the computing device 106 is a motor controller or other industrial control device. Typically, the power supply 114 connects to a voltage supply, such as an AC power source or a DC bus, and converts input power to a low voltage DC signal or AC control power signal. In some embodiments, the power supply 114 provides different voltages, such as 12 V DC, 5 V DC, 3.3 V DC, etc. The power supply 114 may provide two or more bus voltages or control voltages.

In some embodiments the power supply 114 is a switchmode power supply, which often creates an amount of ripple that are harmonics of the switching frequency of the power supply 114. In some embodiments, the computing device 106 includes a low Z pass filter 116 that is separate from or part of the power supply 114. In some embodiments, a low pass filter 116 is added to the first conductor 108 to further reduce ripple from the power supply 114 to better distinguish an induced signal from the second conductor 110 from ripple on the first conductor 108. In other embodiments, ripple from the power supply 114 is low enough that another low pass filter 116 is not needed. Typically, the low pass filter 116 includes a combination of inductors and capacitors configured and sized to minimize ripple in a particular frequency range. In some examples, the low pass filter 116 is designed to reduce ripple at the switching frequency of the power supply 114 as well as for some relevant or sizable harmonics, such as the third harmonic, the fifth harmonic, etc.

The computing device 106 includes a processor 118 and memory 122. The processor 118 executes code, which may be temporarily stored in the memory 122. The memory 122 is typically volatile memory, such as random-access memory (“RAM”) or the like. Typically, the computing device 106 also includes non-volatile storage (not shown), which is used to store data and program code executable by the processor 118. In some embodiments, the non-volatile storage stores data and/or code for the controller 104. In other embodiments, the controller 104 has separate memory, non-volatile storage, etc.

The component 120 connected to the second conductor 110 may be any device that receives a digital signal, other than the controller 104. While the controller 104 also receives digital signals, a feature of the embodiments described herein is to minimize the number of pins of the controller 104. While a single component 120 is depicted in FIG. 1 connected to the second conductor 110, other embodiments will include other components 120 that connect to a digital signal.

In some embodiments where the computing device 106 includes a service processor, the service processor connects to a management server 124 over a management network 126. Typically, the management network is a private network separate from another computer network used by the computing device 106 to service workloads, receive instructions, communicate with clients, etc. In some embodiments, the service processor is able to control the computing device 106 with or without execution of the processor 118 and may be able to boot the processor 118. A service processor typically monitors functions of a computing device 106, such as fan speed, voltages, etc. and communicates information to the management server 124 and also receives information and instructions from the management server 124.

The management network 126 is typically a private network and may include a LAN, a WAN, a fiber network, and may include a wireless connection and may include a combination of networks. In some embodiments, the management server 124 communicates with a service processor over a public network using encrypted messages. The computer network serving the computing device 106 may also include a WAN, a LAN, a fiber network, the Internet, a wireless connection, or a combination thereof.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM” ®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

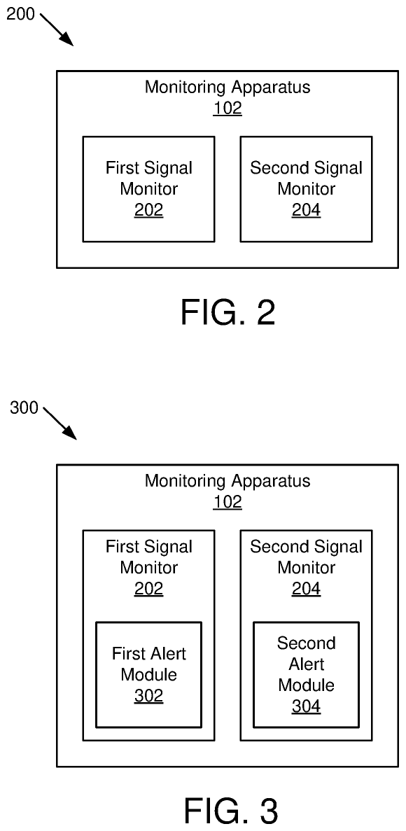

FIG. 2 is a schematic block diagram illustrating an apparatus 200 for combining low frequency and high frequency telemetry using coupled conductors, according to various embodiments. The apparatus 200 includes a monitoring apparatus 102 with a first signal monitor 202 and a second signal monitor 204, which are described below. The monitoring apparatus 102, in various embodiments, may be part of a controller 104 and may be at least partially implemented using hardware circuits and/or a programmable hardware device. For example, a portion of the monitoring apparatus 102 may include an analog-to-digital converter connected to a pin of the controller 104 where the first conductor 108 is connected to the pin. The analog-to-digital controller provides a digitized version of a signal on the first conductor 108, including the first signal and an induced signal that is induced at the coupling section 112 by the second signal of the second conductor 110. In other embodiments, the monitoring apparatus 102 is implemented in program code where the controller 104 includes hardware circuits that provide digital information to the monitoring apparatus 102. One of skill in the art will recognize other ways to implement the monitoring apparatus 102 and other locations to implement the monitoring apparatus 102.

The apparatus 200 includes a first signal monitor 202 configured to monitor the first signal present on the pin of the controller 104 and to report a status of the first signal. For example, the first conductor 108 may be connected to a 3.3 V DC bus and the first signal includes a voltage level from the 3.3 V DC bus. In the embodiments, the first signal monitor 202 monitors a voltage level of the 3.3 V DC bus and may report if the voltage level is above a threshold in a normal range, below a threshold in an abnormal range, may report a voltage level of zero where the voltage on the pin is zero, etc. Where the first signal includes a low frequency signal component, such as a 24 V AC control power signal,

The apparatus 200 includes a second signal monitor 204 configured to monitor the second signal by monitoring the induced signal present on the pin and to report a status of the second signal based on the induced signal. The first signal is a low frequency signal and the second signal is a high frequency signal with respect to the low frequency of the first signal. In some embodiments, the first signal is a DC signal. Where the first conductor 108 is connected to a power supply 114, the power supply may be a switchmode power supply that is, for example, switching in the kilohertz range, which may induce a ripple onto the first conductor 108. However, the ripple is unwanted and is filtered either by the low pass filter 116 or within the power supply 114. Typically, the first signal monitor 202 is monitoring the DC signal and is not monitoring the ripple. The coupling section 112, in some embodiments, is configured to create a coupling coefficient between the first conductor 108 and the second conductor 110 sufficient such that the induced signal has a maximum amplitude that is detectable by the second signal monitor 204 and is smaller than a maximum amplitude of the first signal.

In other embodiments, the first conductor 108 is monitoring another low frequency signal, such as incoming power at 50 Hz, 60 Hz, 400 Hz, or other relatively low frequency compared to the high frequency signal component of the second conductor 110. The second signal on the second conductor 110 is at least an order of magnitude higher than the low frequency of the first signal. In some embodiments, the second signal is a digital signal and operates at a typical digital frequency, such as 500 kHz up to around 500 megahertz (“MHz”). However, the invention is not so limited and the second signal on the second conductor 110 may be higher than 500 MHz as clock speeds for computing devices 106 increase over time. The second signal may also be lower than 500 kHz and may be any frequency that may be coupled onto the first conductor 108 and is distinguishable from the first signal.

In some embodiments, the second signal monitor 204 monitors whether or not the induced signal is present or not. In other embodiments, the induced signal is accurate enough so that the second signal monitor 204 monitors digital information on the induced signal. In some examples, the second signal is a clock signal and the induced signal is an accurate enough replica of the second signal so that the second signal monitor 204 is able to monitor a frequency and signal quality of the clock signal. In other embodiments, the second signal monitor 204 monitors an amplitude of the induced signal and the induced signal matches or is a ratio of an amplitude of the second signal. In some embodiments, the second signal monitor 204 determines whether a voltage level of the induced signal is above or below a threshold to determine a status of the second signal. One of skill in the art will recognize other ways that the second signal monitor 204 is able to monitor the second signal based on the induced signal.

The second signal monitor 204 is configured to report a status of the second signal based on the induced signal. For example, the induced signal may be below a threshold and the second signal monitor 204 then reports that the second signal is off, has a low voltage, or the like, or reports that the second signal is operating normally. One of skill in the art will recognize other information that the second signal monitor 204 is able to report based on monitoring the induced signal on the pin of the controller 104.

In some embodiments, the first signal monitor 202, the second signal monitor 204, the monitoring apparatus 102, and/or controller 104 includes signal processing capable of allowing the first signal monitor 202 to monitor the first signal while excluding effects of the second signal and allowing the second signal monitor 204 to monitor the second signal while excluding effects of the first signal.

In some embodiments, the first signal monitor 202, the second signal monitor 204, the monitoring apparatus 102, and/or controller 104 uses a Fast Fourier Transform, a digital filter, or the like to separate the first signal from the second signal by way of the induced signal, to isolate the induced signal from the first signal, etc. A Fast Fourier Transform is an algorithm that computes a discrete Fourier transform (“DFT”) of a sequence or the inverse of the discrete Fourier transform (“IDFT”). Fourier analysis converts a signal from an original domain to a representation in the frequency domain and vice versa. The DFT is obtained by decomposing a sequence of values into components of different frequencies, each with an amplitude. Typically, use of a Fast Fourier Transform is computationally feasible and results in a series of discrete frequencies and associated amplitudes that if recombined would reconstitute the original signal.

A digital filter is a system in digital signal processing that performs a mathematical function on a sampled discrete-time signal to reduce or enhance certain aspects of the signal. In some examples, the first signal monitor 202 uses a low pass digital filter to filter out effects of the induced signal. in other examples, the second signal monitor 204 uses a band pass or high pass filter to filter out effects of the first signal, effects of ripple on the first signal, etc. One of skill in the art will recognize other digital signal processing techniques to separate the first signal from the induced signal representing the second signal.

FIG. 3 is a schematic block diagram illustrating another apparatus 300 for combining low frequency and high frequency telemetry using coupled conductors, according to various embodiments. The apparatus 300 includes a monitoring apparatus 102 with a first signal monitor 202 and a second signal monitor 204 that are substantially similar to those of the apparatus 200 of FIG. 2. In various embodiments, the apparatus 300 includes a first alert module 302 and/or a second alert module 304, which are described below. In various embodiments, the apparatus 300 is implemented similarly to the apparatus 200 of FIG. 2.

The apparatus 300 includes a first alert module 302 configured to report a status of the first signal and/or an anomaly associated with the first signal. In some embodiments, the first alert module 302 reports the status or anomaly of the first signal to the management server 124, to a system administrator, or other external computing device. In other embodiments, the first alert module 302 reports the status and/or an anomaly of the first signal to the controller 104, to the processor 118, or other component within the computing device 106. In some examples, an operating system of the computing device 106 uses the reported information from the first alert module 302 to halt operations, to make corrections, etc. In some examples, the first alert module 302 reports a voltage below a threshold by way of an interrupt. In other examples, the first alert module 302 reports a status or anomaly of the first signal as an error message on a bus, as an alert to a user, or the like. One of skill in the art will recognize other ways to utilize reported status or an anomaly from the first alert module 302.

The apparatus 300 includes a second alert module 304 configured to report a status of the second signal and/or an anomaly associated with the second signal based on the second signal monitor monitoring the induced signal. In some embodiments, the second alert module 304 reports the status or anomaly of the second signal to the management server 124, to a system administrator, or other external computing device. In other embodiments, the second alert module 304 reports the status and/or an anomaly of the second signal to the controller 104, to the processor 118, or other component within the computing device 106. In some examples, the operating system of the computing device 106 uses the reported information from the second alert module 304 to halt operations, to make corrections, to reboot a section of code, etc. In some examples, the second alert module 304 reports a peak-to-peak voltage below a threshold by way of an interrupt. In other examples, the second alert module 304 reports a status or anomaly of the second signal as an error message on a bus, as an alert to a user, or the like. One of skill in the art will recognize other ways to utilize reported status or an anomaly from the second alert module 304.

FIG. 4 is a schematic block diagram 400 illustrating a first configuration for combining low frequency and high frequency telemetry using coupled conductors using printed circuit board traces, according to various embodiments. The first conductor 108 is depicted coming from a DC source, such as the power supply 114 and/or a low pass filter 116, and passing through a coupling section 112 before reaching a pin on the controller Z 104. The second conductor 110 is depicted coming from a digital source. The digital source may be the processor 118, from another controller, from a component, or other source of a digital signal known to those of skill in the art. The second conductor 110 runs through the coupling section 112 to a digital endpoint, such as the component 120 of FIG. 1.

The coupling section 112 is intended to depict traces on a printed circuit N board (“PCB”) running close enough to have a coupling coefficient sufficient so that an induced signal is induced on the first conductor 108 based on the second signal. In some embodiments, a distance between the first conductor 108 and the second conductor 110 and the adjoining length of the first and second conductors 108, 110 depends on a variety of factors. The most critical factors include the frequency of the second signal, an available resolution of the of the analog-to-digital converter, and a dielectric constant of a PCB dielectric material. Through simulation, an optimal PCB layout may be determined to achieve a desired amount of high frequency noise or a resolution, amplitude, etc. of the induced signal. The amplitude of a high frequency signal Vᵣ can be calculated by:

Vᵣ=VₚₚCₘZl_{eq}/Tᵣ

where Vₚₚ is the amplitude of the high frequency second signal, Cm is a mutual capacitance between the first conductor 108 and the second conductor 110 (this value also depends on dielectric, distance, and adjoining length), Z is the impedance of the DC first signal net, leq is a length of the coupling section 112, and Tr is a rise time of the high frequency second signal.

This equation and associated parameters may be used to design an appropriate amplitude of the induced signal with respect to a resolution of the analog-to-digital converter in the controller 104 and an expected voltage of the first signal on the first conductor 108. Thus, the amplitude Vᵣ may be designed to be above a minimum resolution of the analog-to-digital converter. For example, if the resolution is 0.1 V, the amplitude Vᵣ of the induced signal may be designed to be at least 0.2 V. Likewise, the amplitude Vᵣ of the induced signal may be designed to not overwhelm a voltage level of the first signal. For example, where the first signal is a 3.3 V DC bus and a threshold for reporting that the 3.3 V DC bus is off or anomalous is 2.0 V DC, the amplitude Vᵣ of the induced signal may U be designed to be no more than 1 V DC. One of skill in the art will recognize other considerations in choosing an amplitude Vᵣ of the induced signal.

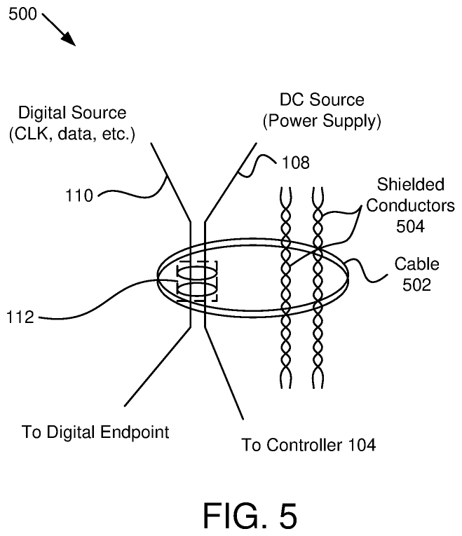

FIG. 5 is a schematic block diagram 500 illustrating a second configuration for combining low frequency and high frequency telemetry using coupled conductors of a cable, according to various embodiments. In the diagram 500, the first conductor 108 and second conductor 110 are in a cable 502. In some embodiments, the cable 502 includes a covering, which may provide protection from damage, provide insulation, provide electromagnetic shielding, and/or the like. In some embodiments, the cable 502 includes other shielded conductors 504 that have shielding so that energy radiated from the first conductor 108 and/or second conductor 110 does not affect the shielded conductors 504.

Within the cable 502, at least a portion of the first conductor 108 and second conductor 110 are unshielded and in close proximity in a coupling section 112 to induce the high frequency signal component of the second conductor 110 onto the first conductor 108. In some embodiments, the coupling section 112 is limited to a portion of the cable 502. In other embodiments, the coupling section 112 runs an entire length of the cable 502. As the coupling section 112 expands, amplitude of the induced signal increases, but would typically be limited based on amplitude of the second signal in the second conductor 110. One of skill in the art will recognize other ways to include a coupling section 112 within a cable 502.

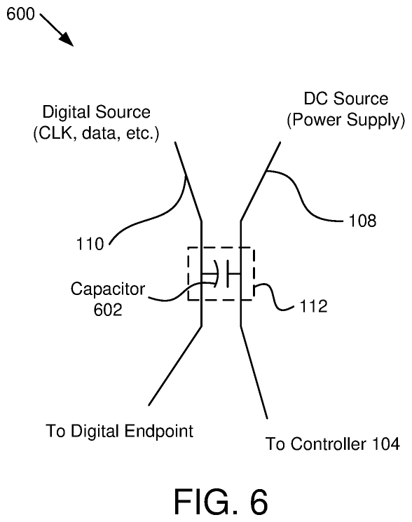

FIG. 6 is a schematic block diagram 600 illustrating a third configuration for combining low frequency and high frequency telemetry using coupled conductors using a coupling capacitor 602, according to various embodiments. The diagram 600 illustrates a first conductor 108 coupled to a second conductor 110 via a coupling capacitor 602 within a coupling section 112. In some embodiments, the first conductor 108 and the second conductor 110 are in close proximity within the coupling section 112. In the embodiments, coupling may include coupling by way of the coupling capacitor 602 in addition to proximity of the first conductor 108 to the second conductor 110. In other embodiments, the first conductor 108 and the second conductor 110 are separated in the coupling section 112 and the coupling capacitor 602 is connected to the first conductor 108 and/or to the second conductor 110 using a length of conductor. Having a coupling capacitor 602, in some embodiments, provides a coupling coefficient that may be adjusted by adjusting capacitance of the coupling capacitor 602, and thus provides a controllable design parameter.

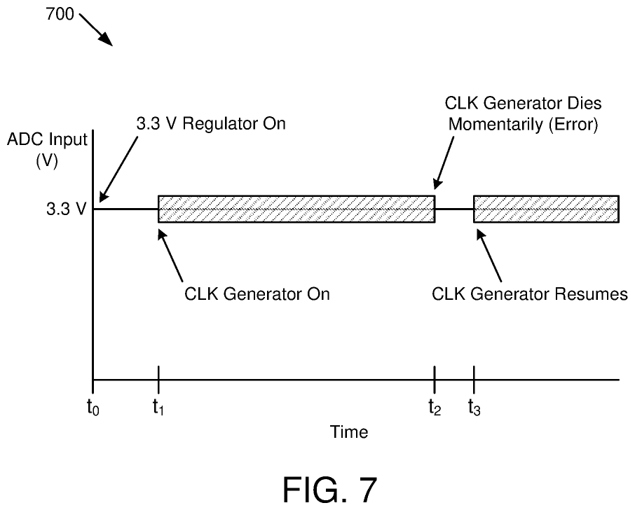

FIG. 7 is a voltage versus time diagram 700 illustrating a DC signal and an induced signal, according to various embodiments. The diagram 700 illustrates a DC voltage of 3.3 V DC, such as would be expected on a 3.3 V DC bus. In the example of the diagram 700 of FIG. 7, the second signal is a clock signal CLK. Typically, the 3.3 V DC bus voltage remains fairly stable, but may vary due to transient loading conditions. The second conductor 110 induces the induced signal onto the 3.3 V DC bus. At time to, only the 3.3 V DC from the first conductor 108 is present. At time t₁, the clock signal starts and has a peak-to-peak amplitude of about 0.5 V, which is depicted by a shaded box. At time t2, the clock signal stops momentarily and restarts at time t₃, which may indicate an error or other problem with the clock generator, in which case, in some embodiments the second alert module 304 sends an alert indicating the momentary loss of the clock signal.

Note that the amplitude of the clock signal is much lower than the amplitude of the 3.3 V DC bus voltage. In some embodiments, the amplitude of the induced signal is designed to be higher than noise or ripple on the first conductor 108 but small enough to not interfere with reading the first signal by the first signal monitor 202. One of skill in the art will recognize appropriate voltages to be induced onto the first conductor 108.

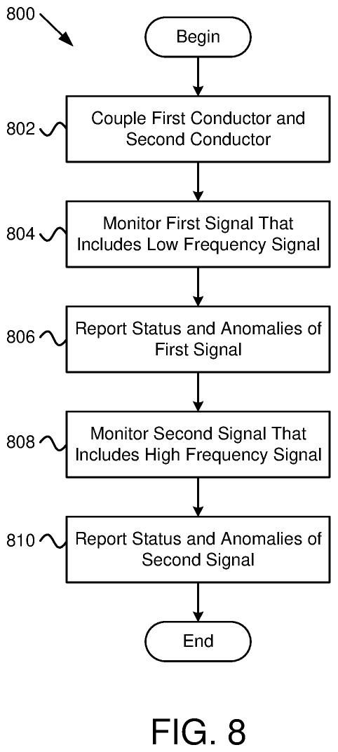

FIG. 8 is a schematic flow chart diagram illustrating a method 800 for combining low frequency and high frequency telemetry using coupled conductors, according to various embodiments. The method 800 begins and couples 802 a first conductor 108 and a second conductor 110 within a coupling section 112. The first conductor 108 is connected to a pin of a controller 104 and includes a first signal with a low frequency signal component. The low frequency first signal may be a DC signal. The second conductor 110 includes a second signal that is a high frequency signal component that is at least an order of magnitude higher than the low frequency signal component of the first signal. The coupling section 112 includes a portion of the first conductor 108 situated in proximity to a portion of the second conductor 110 where the high frequency signal component of the second signal on the second conductor 110 induces an induced signal on the first conductor 108 within the coupling section 112.

The method 800 monitors 804 the first signal with a low frequency signal component that is present on the pin of the controller 104. The low frequency signal component, in some embodiments, includes a DC signal. The method 800 reports 806 a Z status and anomalies of the first signal. The method 800 monitors 808 a second signal of the second conductor 110 by monitoring the induced signal present on the pin of the controller 104 and reports 810 a status and/or anomalies of the second signal based on the induced signal, and the method 800 ends. In various embodiments, all or a portion of the method 800 is implemented using the coupling section 112 that includes the first conductor 108 and the second conductor 110, the pin of the controller 104, the first signal monitor 202, the first alert module 302, the second signal monitor 204, and/or the second alert module 304.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a first conductor connected to a pin of a controller, the first conductor comprising a first signal comprising a low frequency signal component;
a second conductor comprising a second signal, the second signal comprising a high frequency signal component; and
a coupling section comprising a portion of the first conductor situated in proximity to a portion of the second conductor, wherein the high frequency signal component of the second signal on the second conductor induces an induced signal on the first conductor within the coupling section, wherein the induced signal comprises the high frequency signal component that is at least an order of magnitude higher than the low frequency signal component;
the controller comprising:
a first signal monitor configured to monitor the first signal present on the pin of the controller and to report a status of the first signal; and
a second signal monitor configured to monitor the second signal by monitoring the induced signal present on the pin and to report a status of the second signal based on the induced signal.

2. The apparatus of claim 1, wherein the first conductor monitors a direct current (“DC”) signal and wherein the controller comprises an analog-to-digital converter connected to the pin of the controller configured to provide a digitized version of an analog signal present at the pin to the first signal monitor, wherein the first signal monitor monitors a DC level of the first conductor.

3. The apparatus of claim 1, wherein the second signal of the second conductor comprises a digital signal and wherein the controller comprises an analog-to-digital converter connected to the pin of the controller configured to provide a digitized version of an analog signal at the pin to the second signal monitor and wherein the second signal monitor monitors a frequency of the induced signal matching a frequency of the digital signal.

4. The apparatus of claim 3, wherein the second signal monitor utilizes one of a Fast Fourier Transform and a digital filter.

5. The apparatus of claim 3, wherein the second signal monitor monitors:
an amplitude of the induced signal; and/or
presence and non-presence of the induced signal.

6. The apparatus of claim 1, wherein the coupling section comprises a portion of the first conductor and a portion of the second conductor configured as traces on a printed circuit board (“PCB”) situated in close proximity to induce the high frequency signal component of the second conductor onto the first conductor.

7. The apparatus of claim 1, wherein the coupling section comprises a portion of the first conductor and a portion of the second conductor configured in a cable, wherein the portion of the first conductor and the portion of the second conductor are unshielded and are in close proximity to induce the high frequency signal component of the second conductor onto the first conductor.

8. The apparatus of claim 1, wherein the coupling section comprises a coupling capacitor coupled the first conductor and to the second conductor at the coupling section, wherein the coupling capacitor is sized and situated to induce the high frequency signal component of the second conductor onto the first conductor.

9. The apparatus of claim 1, further comprising a low pass filter configured to filter the first conductor, wherein the coupling section is positioned between the low pass filter and the pin of the controller.

10. The apparatus of claim 1, wherein the coupling section is configured to create a coupling coefficient between the first conductor and the second conductor sufficient such that the induced signal has a maximum amplitude that is detectable Z by the second signal monitor and is smaller than a maximum amplitude of the first signal.

11. The apparatus of claim 1, further comprising a first alert module configured to report a status of the first signal and/or an anomaly associated with the first signal, and further comprising a second alert module configured to report a status of the second signal and/or an anomaly associated with the second signal based on the second signal monitor monitoring the induced signal.

12. An apparatus comprising:
a first conductor connected to a pin of a controller, the first conductor comprising a first signal comprising a direct current (“DC”) voltage;
a second conductor comprising a second signal comprising a digital signal; and
a coupling section comprising a portion of the second conductor situated in proximity to a portion of the first conductor, wherein a frequency the digital signal of the second signal of the second conductor induces an induced signal on the first conductor within the coupling section, wherein the induced signal comprises the frequency of the digital signal that is at least an order of magnitude higher than harmonic frequencies of the first signal;
the controller comprising;
a first signal monitor configured to monitor the first signal present on the pin of the controller and to report a status of the first signal; and
a second signal monitor configured to monitor the second signal by monitoring the induced signal present on the pin and to report a status of the second signal based on the induced signal.

13. The apparatus of claim 12, wherein the controller comprises an analog-to-digital converter connected to the pin of the controller, the analog-to-digital converter providing a digitized version of an analog signal present at the pin of the controller to the first signal monitor and to the second signal monitor.

14. The apparatus of claim 13, wherein:
the second signal monitor utilizes one of a Fast Fourier Transform and a digital filter; and/or
the second signal monitor monitors an amplitude of the induced signal and/or presence and non-presence of the induced signal.

15. The apparatus of claim 12, wherein:
the coupling section comprises a portion of the first conductor and a portion of the second conductor configured as traces on a printed circuit board (“PCB”) situated in close proximity to induce the digital signal of the second conductor onto the first conductor;
the coupling section comprises a portion of the first conductor and a portion of the second conductor configured in a cable, wherein the portion of the first conductor and the portion of the second conductor are unshielded and are in close proximity to induce the digital signal of the second conductor onto the first conductor; and/or
the coupling section comprises a coupling capacitor coupled the first conductor and to the second conductor at the coupling section, wherein the coupling capacitor is sized and situated to induce the digital signal of the second conductor onto the first conductor.

16. The apparatus of claim 12, further comprising a low pass filter configured to filter the first conductor, wherein the coupling section is positioned between the low pass filter and the pin of the controller.

17. The apparatus of claim 12, wherein the coupling section is configured to create a coupling coefficient between the first conductor and the second conductor sufficient such that the induced signal has a maximum amplitude that is detectable by the second signal monitor and is smaller than a maximum of the first signal.

18. The apparatus of claim 12, further comprising a first alert module configured to report a status of the first signal and/or an anomaly associated with the first signal, and further comprising a second alert module configured to report a status of the second signal and/or an anomaly associated with the second signal based on the second signal monitor monitoring the induced signal.

19. A computing device comprising:
a processor;
N a memory coupled to the processor;
a power supply;
a first conductor connected to the power supply and to a pin of a controller, the first conductor comprising a first signal comprising a low frequency signal component;
a second conductor comprising a second signal, the second signal comprising a high frequency signal component; and
a coupling section comprising a portion of the first conductor situated in proximity to a portion of the second conductor, wherein the high frequency signal component of the second signal on the second conductor induces an induced signal on the first conductor within the coupling section, wherein the induced signal comprises the high frequency signal component that is at least an order of magnitude higher than the low frequency signal component;
the controller comprising;
a first signal monitor configured to monitor the first signal present on the pin of the controller and to report a status of the first signal; and
a second signal monitor configured to monitor the second signal by monitoring the induced signal present on the pin and to report a status of the second signal based on the induced signal.

20. The computing device of claim 19, further comprising:
a low pass filter configured to filter the first conductor, wherein the coupling section is positioned between the low pass filter and the pin of the controller; and/or
a first alert module configured to report a status of the first signal and/or an anomaly associated with the first signal, and further comprising a second alert module configured to report a status of the second signal and/or an anomaly associated with the second signal based on the second signal monitor monitoring the induced signal.
